(19) United States
(12) Patent Application Publication
(10) Pub. No.: US 2023/0044863 A1
(43) Pub. Date: Feb. 9, 2023

(54) METHOD AND SYSTEM FOR RECOMMENDATION OF COGNITIVE AND SKILL BASED LEARNING COMPETENCIES

(71) Applicant: Tata Consultancy Services Limited, Mumbai (IN)

(72) Inventors: ASHISH VIJAY TOPLE, Pune (IN); HIMANSHU RAMESH JAIN, Pune (IN); PANDIT ASHISH SHARMA, Pune (IN); ANIKET VINAYAK KOLEE, Pune (IN)

(73) Assignee: Tata Consultancy Services Limited, Mumbai (IN)

(21) Appl. No.: 17/655,158

(22) Filed: Mar. 16, 2022

(30) Foreign Application Priority Data
Jul. 29, 2021 (IN) 202121034196

(51) Int. Cl. G06N 5/04; G06N 5/02; G09B 7/06

(52) U.S. Cl. CPC G06N 5/04; G06N 5/022; G09B 7/06

(57) ABSTRACT

This disclosure relates to the field of recommendation of learning competencies. The usage of competency-based learning platforms is growing as it provides a safe learning environment where learners/users can learn from the comfort of their homes at a convenient time. However, one of the challenges with competency-based learning platforms is to identify learning competencies/courses relevant to a learner as exhaustive material is available on the internet. The disclosure addresses the challenges by providing techniques for personalized recommendation of cognitive based learning competencies and skill based learning competencies. The disclosed techniques recommend cognitive based learning competencies and skill based learning competencies based on several techniques that include a machine learning, Natural Language Processing (NLP), a skill based recommendation technique and a collaborative cognitive recommendation technique. Hence the disclosure is an approach to enable a learner to assess the learner's current competencies and identify learning competencies required for a desired role.

### PRIORITY CLAIM

This U.S. patent application claims priority under 35 U.S.C. § 119 to: India Application No. 202121034196, filed on 29 Jul. 2021. The entire contents of the aforementioned application are incorporated herein by reference

### TECHNICAL FIELD

The disclosure herein generally relates to the field of recommendation of learning competencies, and, more particularly, to a method and a system for recommendation of cognitive and skill based learning competencies.

### BACKGROUND

A learning platform is an integrated set of interactive online services for educational purposes with information, tools and resources to support and enhance educational delivery and management to help a learner achieve a required competency. Further a competency-based learning platform refers to interactive online services of teaching/training, assessment, grading, and academic reporting for learners, that demonstrate that learners have gained the knowledge and skills expected to be proficient for their education or jobs.

The usage of competency-based learning platforms is growing, especially after the advent of Covid disease, as online platforms provide a safe learning environment where learners can learn from the comfort of their homes at a convenient time. However, with exhaustive material available on the internet with several learning courses on numerous learning platforms, it becomes a challenging task for a learner to identify relevant and personalized competencies.

The existing state-of-art techniques recommend competency-based learning courses based on historical data about the learner's previous likings/learning pattern. Further, some of the existing state-of-art techniques address the need for learning recommendations but do not consider individuality, cognitive ability and skill gaps of the learner. While considering the individual abilities, it is also important to identify other individuals with similar cognitive abilities to analyze the competencies gained by learner to allow an all-round development for enabling skill development.

### SUMMARY

Embodiments of the present disclosure present technological improvements as solutions to one or more of the above-mentioned technical problems recognized by the inventors in conventional systems. For example, in one embodiment, a method and a system for recommendation of cognitive and skill based learning competencies is provided. The system includes a memory storing instructions, one or more communication interfaces; and one or more hardware processors coupled to the memory via the one or more communication interfaces, wherein the one or more hardware processors are configured by the instructions to receive a first input from a plurality of sources, wherein the first input comprises information on a plurality of learning competencies associated with the plurality of sources, wherein the plurality of sources comprises a plurality of competency learning platforms. The system is further configured to generate a competency catalogue base by applying a machine learning technique on the first input, via the one or more hardware processors, wherein the competency catalogue base comprises of the plurality of learning competencies. The system is further configured to receive a second input associated with a user, via the one or more hardware processors, wherein the second input comprises a current competency of the user, a resume of the user, and a cognitive score of the user. The system is further configured to classify the current competency of the user to one of an acquired competency, an additionally acquired competency, and a to-acquire competency, via the one or more hardware processors, using the plurality of second input and the competency catalogue base. The system is further configured to recommend a set of learning competencies for the user based on the classification, via the one or more hardware processors, by performing one of: upon classifying the current competency of the user as the to-acquire competency, performing a skill based recommendation technique and a collaborative cognitive recommendation technique using the competency catalogue base and the second input, or upon classifying the current competency of the user as the acquired competency, performing the collaborative cognitive recommendation technique using the competency catalogue base and the second input and upon classifying the current competency of the user as the additionally acquired competency, performing the collaborative cognitive recommendation technique using the competency catalogue base and the second input.

In another aspect, a method for recommendation of cognitive and skill based learning competencies is provided. The method includes receiving a first input from a plurality of sources, wherein the first input comprises information on a plurality of learning competencies associated with the plurality of sources, wherein the plurality of sources comprises a plurality of competency learning platforms. The method further generating a competency catalogue base by applying a machine learning technique on the first input, wherein the competency catalogue base comprises of the plurality of learning competencies. The method further receiving a second input associated with a user, wherein the second input comprises a current competency of the user, a resume of the user, and a cognitive score of the user. The method further classification of the current competency of the user to one of an acquired competency, an additionally acquired competency, and a to-acquire competency, using the plurality of second input and the competency catalogue base. The method further includes recommendation of a set of learning competencies for the user based on the classification, by performing one of: upon classifying the current competency of the user as the to-acquire competency, performing a skill based recommendation technique and a collaborative cognitive recommendation technique using the competency catalogue base and the second input, or upon classifying the current competency of the user as the acquired competency, performing the collaborative cognitive recommendation technique using the competency catalogue base and the second input and upon classifying the current competency of the user as the additionally acquired competency, performing the collaborative cognitive recommendation technique using the competency catalogue base and the second input.

In yet another aspect, a non-transitory computer readable medium for recommendation of cognitive and skill based learning competencies is provided. The program includes receiving a first input from a plurality of sources, wherein the first input comprises information on a plurality of learning competencies associated with the plurality of sources, wherein the plurality of sources comprises a plurality of competency learning platforms. The program includes generation of a competency catalogue base by applying a machine learning technique on the first input, wherein the competency catalogue base comprises of the plurality of learning competencies. The program includes receiving a second input associated with a user, wherein the second input comprises a current competency of the user, a resume of the user, and a cognitive score of the user. The program includes classification of the current competency of the user to one of an acquired competency, an additionally acquired competency, and a to-acquire competency, using the plurality of second input and the competency catalogue base. The program includes recommending of a set of learning competencies for the user based on the classification, by performing one of: upon classifying the current competency of the user as the to-acquire competency, performing a skill based recommendation technique and a collaborative cognitive recommendation technique using the competency catalogue base and the second input, or upon classifying the current competency of the user as the acquired competency, performing the collaborative cognitive recommendation technique using the competency catalogue base and the second input and upon classifying the current competency of the user as the additionally acquired competency, performing the collaborative cognitive recommendation technique using the competency catalogue base and the second input.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary system for recommendation of cognitive and skill based learning competencies according to some embodiments of the present disclosure.

FIG. 2 is a functional block diagram of the system (100) for recommendation of cognitive and skill based learning competencies according to some embodiments of the present disclosure.

FIG. 3A and FIG. 3B is a flow diagram (300) illustrating a method for recommendation of cognitive and skill based learning competencies in accordance with some embodiments of the present disclosure.

FIG. 4 is a flow diagram (400) illustrating a method for skill based recommendation technique for recommendation of cognitive and skill based learning competencies in accordance with some embodiments of the present disclosure.

FIG. 5 is an example scenario illustrating a second input (resume) for recommendation of cognitive and skill based learning competencies in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

The usage of competency-based learning platforms is growing, as it provides a safe learning environment where learners/users can learn from the comfort of their homes at a convenient time. However, one of the challenges with competency-based learning platforms is to identify learning competencies/courses relevant to a learner's current status as exhaustive material is available on the internet. The disclosed techniques for recommendation of cognitive and skill based learning competencies are based on an individual learner's current profile/current status. The embodiments of the disclosure empower the learner/user to choose from both cognitive learning competencies and skill based learning competencies. The disclosed technique for recommendation of cognitive and skill based learning competencies can be used in different scenarios. In an embodiment, the learner can be a person seeking new employment or appearing for competitive exams, wherein the disclosure assists the learner assess his/her current knowledge level (cognitive and skill based) and also recommends the relevant competencies that would assist the learner to get a new employment or clear competitive exams. In another embodiment, the learner can be a person who is employed and wishes to enhance his/her knowledge base to remain relevant in a competitive setup, wherein the disclosure assists the learner assess his/her current knowledge level (cognitive and skill based) and also recommends the relevant competencies that would assist the learner to get a new employment. In another embodiment, the learner can also be an employment portal that assists persons in employment, wherein the employment portal can utilize the disclosed techniques, to assists the learner assess his/her current knowledge level (cognitive and skill based) and also recommends the relevant competencies that would assist the learner to get a new employment.

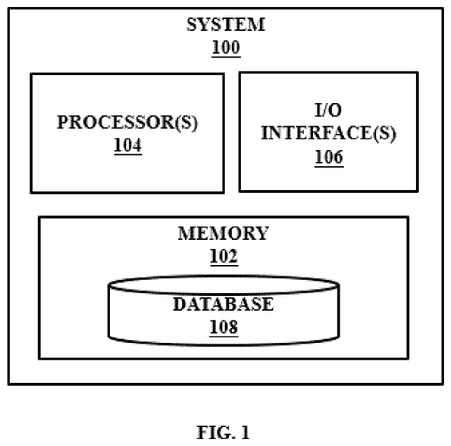

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 is a functional block diagram of a system 100 for recommendation of cognitive and skill based learning competencies in accordance with some embodiments of the present disclosure.

In an embodiment, the system 100 includes a processor(s) 104, communication interface device(s), alternatively referred as input/output (I/O) interface(s) 106, and one or more data storage devices or a memory 102 operatively coupled to the processor(s) 104. The system 100 with one or more hardware processors is configured to execute functions of one or more functional blocks of the system 100.

Referring to the components of system 100, in an embodiment, the processor(s) 104, can be one or more hardware processors 104. In an embodiment, the one or more hardware processors 104 can be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 is configured to fetch and execute computer-readable instructions stored in the memory 102. In an embodiment, the system 100 can be implemented in a variety of computing systems including laptop computers, notebooks, hand-held devices such as mobile phones, workstations, mainframe computers, servers, a network cloud and the like.

The I/O interface(s) 106 can include a variety of software and hardware interfaces, for example, a web interface, a graphical user interface, a touch user interface (TUI) and the like and can facilitate multiple communications within a wide variety of networks N/W and protocol types, including wired networks, for example, LAN, cable, etc., and wireless networks, such as WLAN, cellular, or satellite. In an embodiment, the I/O interface (s) 106 can include one or more ports for connecting a number of devices (nodes) of the system 100 to one another or to another server.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

Further, the memory 102 may include a database 108 configured to include information regarding learning platforms and competencies. Thus, the memory 102 may comprise information pertaining to input(s)/output(s) of each step performed by the processor(s) 104 of the system 100 and methods of the present disclosure. In an embodiment, the database 108 may be external (not shown) to the system 100 and coupled to the system via the I/O interface 106.

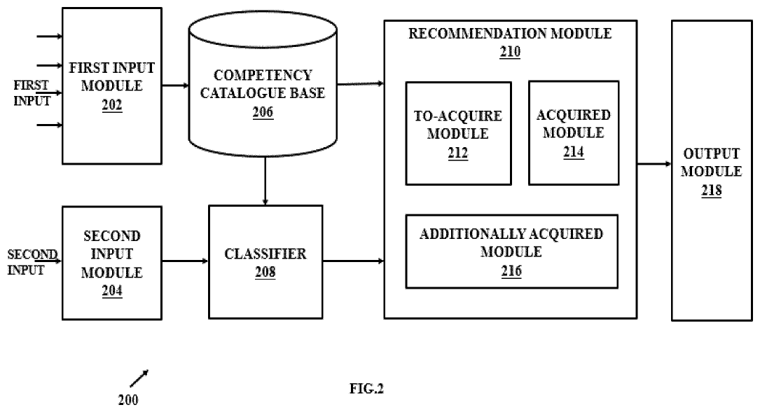

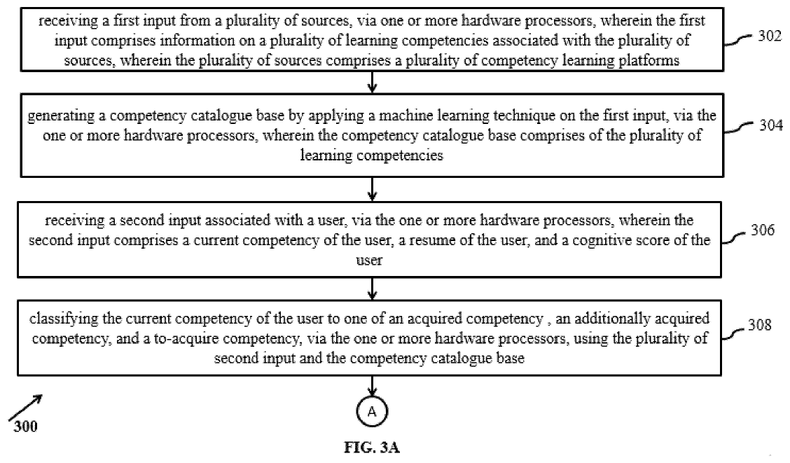

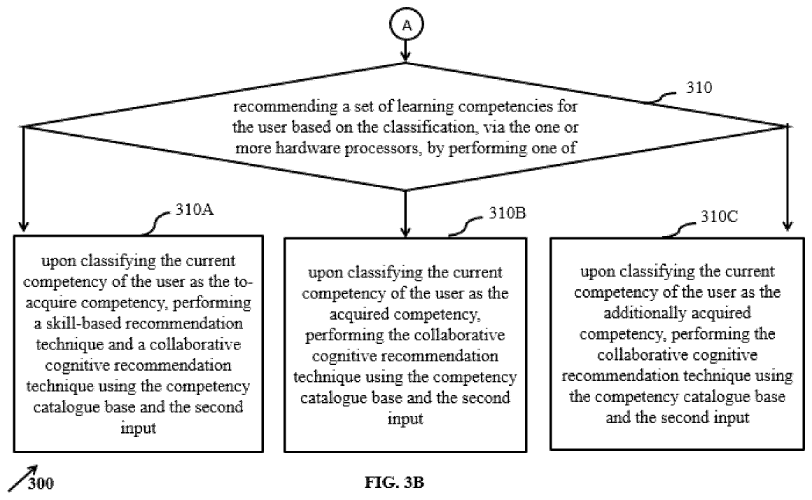

Functions of the components of system 100 are explained in conjunction with functional overview of the system 100 in FIG. 2 and flow diagram of FIGS. 3A and 3B for recommendation of cognitive and skill based learning competencies.

The system 100 supports various connectivity options such as BLUETOOTH®, USB, ZigBee and other cellular services. The network environment enables connection of various components of the system 100 using any communication link including Internet, WAN, MAN, and so on. In an exemplary embodiment, the system 100 is implemented to operate as a stand-alone device. In another embodiment, the system 100 may be implemented to work as a loosely coupled device to a smart computing environment. The components and functionalities of the system 100 are described further in detail.

FIG. 2 is a functional block diagram of the various modules of the system of FIG. 1, in accordance with some embodiments of the present disclosure. As depicted in the architecture, the FIG. 2 illustrates the functions of the components of the system 100 that includes recommendation of cognitive and skill based learning competencies.

The system 200 for recommendation of cognitive and skill based learning competencies is configured to receive a first input from a plurality of sources, wherein the first input comprises information on a plurality of learning competencies associated with the plurality of sources using a first input module 202. The system 200 also comprises a second input module 204 configured to receive a second input associated with a user, wherein the second input includes a current competency of the user, a resume of the user, and a cognitive score of the user. The system 200 further comprises a competency catalogue base 206 generated by applying a machine learning technique that includes a natural language processing (NLP) technique on the first input. The system 200 further comprises of a classifier 208 to classify the current competency of the user to one of an acquired competency, an additionally acquired competency, and a to-acquire competency using the second input and the competency catalogue base. The system 200 further comprises a recommendation module 210 that includes a to-acquire module 212, an acquired module 214 and an additionally acquired module 216 for recommending a set of learning competencies for the user based on the classification. The system 100 further comprises an output module 218 to display the set of learning competencies recommended to the user.

The various modules of the system 100 and the functional blocks in FIG. 2 are configured for recommendation of cognitive and skill based learning competencies are implemented as at least one of a logically self-contained part of a software program, a self-contained hardware component, and/or, a self-contained hardware component with a logically self-contained part of a software program embedded into each of the hardware component that when executed perform the above method described herein.

Functions of the components of the system 200 are explained in conjunction with functional modules of the system 100 stored in the memory 102 and further explained in conjunction with flow diagram of FIG. 3A and FIG. 3B. The FIG. 3A and FIG. 3B with reference to FIG. 1, is an exemplary flow diagram illustrating a method 300 for recommendation of cognitive and skill based learning competencies using the system 100 of FIG. 1 according to an embodiment of the present disclosure.

The steps of the method of the present disclosure will now be explained with reference to the components of the system (100) for recommendation of cognitive and skill based learning competencies and the modules (202-216) as depicted in FIG. 2 and the flow diagrams as depicted in FIG. 3A and FIG. 3B. Although process steps, method steps, techniques or the like may be described in a sequential order, such processes, methods and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

At step 302 of the method (300), a first input is received from a plurality of sources using the first input module 202. The first input comprises information on a plurality of learning competencies associated with the plurality of sources, wherein the plurality of sources comprises a plurality of competency learning platforms.

Each learning competency among the plurality of learning competencies comprises of either a plurality of skill based competencies and a plurality of collaborative cognitive competencies. The plurality of learning competencies is associated with a cognitive factor and the collaborative cognitive competencies is associated with a competency cognitive score. The plurality of skill based competencies further comprises a plurality of skill based courses and a plurality of collaborative cognitive competencies further comprises a plurality of cognitive based courses. In an example scenario, the plurality of skill based competencies includes a Power BI, a Market Research, Effective Communication etc., the plurality of skill based courses includes Advanced Analytics using Power BI, Power BI on Azure Cloud, Market Research for Beginners, Art of Communication etc., the plurality of collaborative cognitive competencies include 3D Animation, Quality Management etc., and the plurality of cognitive based courses include Maya for Beginners: Complete 3D Animation Masterclass, Total Quality Management etc.,

The cognitive factor is associated with each learning competencies from the plurality of learning competencies. The cognitive factor is a pre-defined parameter that represents a complexity of the learning competencies. In an example scenario the complexity of the learning competencies is defined as a simple, a medium and a hard level and the cognitive factor is defined based on the complexity of the learning competencies as a numerical value.

The competency cognitive score is associated with the collaborative cognitive competencies. The competency cognitive score is a pre-defined parameter that represents cognitive abilities required by a person/user to work on the collaborative cognitive competencies and is pre-defined based on a plurality of persons/users and the corresponding cognitive scores. In an embodiment, the competency cognitive score is also saved while performing the recommendation of cognitive and skill based learning competencies using the system 100 as a feedback.

In an embodiment, the plurality of learning competencies is the essential ideas/skills/knowledge required for a specific job or vocation. Hence each learning competency is assigned to atleast one role/profile. Considering an example scenario, the learning competencies required for the role of a software coding engineer is a Java certification, object oriented programming, programming, MYSQL™ certification for database etc., Considering another example scenario, the learning competencies required for the profile of a fashion designer is drawing and computer drafting skills, knowledge of textiles, sewing, and construction.

In an embodiment, the plurality of sources are platforms that offer learning competencies content and assessments to for several learners to create a personalized pathway to success required for a job.

The first input is received and pre-processed to remove duplicates, perform tokenization, wordnet lemmatization, porter stemming, reduce dimensions and generate n-gram tokens that would be further used for generating the competency catalogue base.

At the next step 304 of the method (300), a competency catalogue base 206 is generated by applying a machine learning technique on the first input. The competency catalogue base is a dynamic database that is constantly updated with an exhaustive list of learning competencies content and assessments as available on the plurality of sources. The competency catalogue base comprises of the plurality of learning competencies.

In an embodiment, the machine learning technique comprises a natural language processing (NLP) technique, wherein the NLP technique includes text cleansing, tokenization, lemmatization, vectorization technique.

At the next step 306 of the method (300), a second input associated with a user is received in the second input module 204. The second input comprises a current competency of the user, a resume of the user, and a cognitive score of the user.

In an embodiment, the cognitive score is determined based on a cognitive assessment technique. The cognitive assessment technique comprises determining the cognitive score based on a cognitive assessment test, where the cognitive assessment test comprises a Holland codes test and a Gardeners theory of multiple intelligences test. The cognitive assessment tests are set of questionnaires that would assess the cognitive abilities of the user and assigns a cognitive score to the user based on the user's individual cognitive abilities.

The second input also comprises the current competency of the user and the resume of the user. In an example scenario, the resume of the user will include exhaustive information on the user's current role and responsibilities, the certifications/courses/competencies held by the user and also a desired role of the user. The second input is received and pre-processed to remove duplicates, perform tokenization, lemmatization, port stemming, reduce dimensions and generate n-gram tokens.

At the next step 308 of the method (300), the current competency of the user is classified in the classifier 208. The classification includes one of an acquired competency, an additionally acquired competency, and a to-acquire competency. The classification is performed using the plurality of second input and the competency catalogue base.

In an embodiment, the classification is performed based on a comparison between the current competency of the user and the learning competencies associated with the desired role of the user. Based on the comparison with the desired role and the current competency, the user would have either acquired the competency for which the user is classified into a “to-acquire” competency, or the user would have acquired additional competency for which the user is classified into a “additionally acquired competency” or the user would have to acquired competency required for the desired role for which the user is classified into a “acquired competency”. Hence the user is classified into one of acquired competency, an additionally acquired competency, and a to-acquire competency based on the user's current competency and the user's desired role.

At the next step 308 of the method (300), a set of learning competencies is recommended for the user based on the classification. The set of learning competencies are recommended by performing one of or both of a skill based recommendation technique and a collaborative cognitive recommendation technique based on the classification.

In an embodiment, the set of learning competencies are recommended based on the classification, wherein:

At step 310A of the method (300), upon classifying the current competency of the user as the to-acquire competency, then performing a skill based recommendation technique and a collaborative cognitive recommendation technique using the competency catalogue base and the second input.

In an embodiment, considering an example scenario from a marketing domain, wherein a user's current competencies include developing illustrations for product labels, production of multimedia campaigns, computer aided design CAD software and the user desires to pursue a career (desired role) as an Animator. Upon analyzing the current competencies of the user using the competency catalogue base, the user's current competency is classified for as “the to-acquire competency”, wherein the skill-based recommendation technique and the collaborative cognitive recommendation technique are performed using the competency catalogue base and the second input to identify the gaps between the current competencies and the desired role. The skill based recommendation technique are used to identify and recommend the skill based competencies that include creating two-dimensional and three-dimensional images, design complex graphics and animation, Adobe Illustrator, Adobe Photoshop, Trimble SketchUp Pro. Additionally, based on cognitive abilities of the user, the collaborative cognitive recommendation technique is performed to identify cognitive learning competencies based on cognitive similarities with other users. For the example scenario, if the user is identified to have an Artistic, Social & Enterprising cognitive skills, then based on the user's current cognitive abilities and in comparison with cognitive similarities with other users (correlation) then cognitive competencies including Landscape Design, Landscape Planning, Visual Analysis etc. are recommended that are hyper-personalized for the user in consideration.

At step 310B of the method (300), upon classifying the current competency of the user as the acquired competency, then performing the collaborative cognitive recommendation technique using the competency catalogue base and the second input.

In an embodiment, considering an example scenario from a mechanical engineering domain, wherein a user's current competencies include design mechanical components, fixtures, molds, CAD CAM design, 2D and 3D design, AutoCAD, Inventor, Solid works, Catia-v5, UGS, Pro-E, good communication and the user desires to pursue a career (desired role) as an Mechanical Design Engineer. Upon analyzing the current competencies of the user using the competency catalogue base, the user's current competency is classified for as “the acquired competency”, wherein the collaborative cognitive recommendation technique are performed using the competency catalogue base and the second input to identify cognitive based competencies. In this scenario, the skill based recommendation technique is not performed as the user has acquired the competencies required for the desired role. Hence based on cognitive abilities of the user, the collaborative cognitive recommendation technique is performed to identify cognitive learning competencies based on cognitive similarities with other users. For the example scenario, if the user is identified to have Realistic & Enterprising cognitive skills, then based on the user's current cognitive abilities and in comparison with cognitive similarities with other users (correlation) then cognitive competencies including computer-aided engineering (CAE) analysis, Woodworking, Interpreting 2D, 3D plans, Working ergonomically, health and safety procedures in construction etc., are recommended that are hyper-personalized for the user in consideration.

At step 3100 of the method (300), upon classifying the current competency of the user as the additionally acquired competency, then performing the collaborative cognitive recommendation technique using the competency catalogue base and the second input.

In an embodiment, considering an example scenario from a pharma/healthcare domain, wherein a user's current competencies include Prepack bulk medicines, Fabricate medical devices, Measure the physical or physiological attributes of patients, fill bottles with prescribed medications, and type, Maintain proper storage and security conditions for drugs, Establish or maintain patient profiles, Order, label, and count stock of medications, chemicals, or supplies, Compute charges for medication, Receive written prescription, equipped to handle MEDITECH™ software, Pharmacy management software and the user desires to pursue a career (desired role) as an Pharmacy Technician. Upon analyzing the current competencies of the user using the competency catalogue base, the user's current competency is classified for as “the additionally acquired competency”, wherein the collaborative cognitive recommendation technique are performed using the competency catalogue base and the second input to identify cognitive based competencies. In this scenario, the skill based recommendation technique is not performed as the user has acquired the competencies as well as additional competencies required for the desired role. Hence based on cognitive abilities of the user, the collaborative cognitive recommendation technique is performed to identify cognitive learning competencies based on cognitive similarities with other users. For the example scenario, if the user is identified to have Realistic & Conventional cognitive skills, then based on the user's current cognitive abilities and in comparison with cognitive similarities with other users (correlation) then cognitive competencies including Operate diagnostic or therapeutic medical instruments or equipment, marketing strategy and tactics, product demonstration, sales techniques, meeting quality standards for services, and evaluation of customer satisfaction etc., are recommended that are hyper-personalized for the user in consideration.

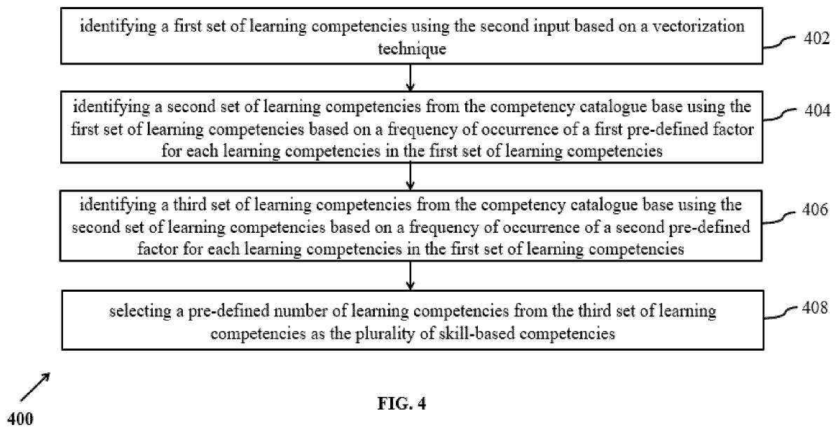

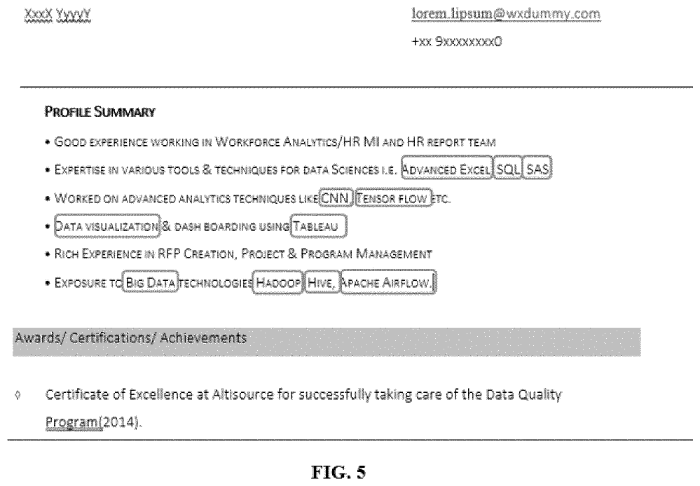

The process of the skill based recommendation technique and the collaborative cognitive recommendation technique is explained in the below sections, using FIG. 4 and FIG. 5.

The process of the skill based recommendation technique is explained using the flowchart of 400 as illustrated in FIG. 4 as explained below:

At step 402 of the method (400), a first set of learning competencies are identified using the second input based on a vectorization technique.

In an embodiment, the vectorization technique includes creating a row vector based on the second input (in an example scenario a title parameter and a description parameter) using an NLP technique, wherein the NLP technique includes a Uni-Gram, a Bi-Gram and a Tri-Gram technique.

At step 404 of the method (400), a second set of learning competencies are identified from the competency catalogue base using the first set of learning competencies. The second set of learning competencies are identified based on a frequency of occurrence of a first pre-defined factor for each learning competencies from the first set of learning competencies.

In an embodiment, the frequency of occurrence of the first pre-defined factor in the first set of learning competency is used to identify the second set of learning competencies, wherein the second set of learning competencies is identified based on maximum frequency of occurrence of the first pre-defined factor in the competency catalogue base. The first pre-defined factor is pre-selected from the second input. In an example scenario, a category parameter (second input) is selected as the first pre-defined factor for identification of the second set of learning competencies, wherein the competency with maximum frequency of occurrence of the category parameter is identified as the second set of learning competencies.

At step 406 of the method (400), a third set of learning competencies are identified from the competency catalogue base using the second set of learning competencies. The third set of learning competencies are identified based on a frequency of occurrence of a second pre-defined factor for each learning competencies from the first set of learning competencies.

In an embodiment, the frequency of occurrence of the second pre-defined factor in the second set of learning competency is used to identify the second set of learning competencies, wherein the third set of learning competencies is identified based on maximum frequency of occurrence of the second pre-defined factor in the competency catalogue base. The second pre-defined factor is pre-selected from the second input. In an example scenario, a title parameter and a description parameter (second input) is selected as the second pre-defined factor for identification of the third set of learning competencies, wherein the competency with maximum frequency of occurrence of the title parameter and the description parameter is identified as the third set of learning competencies.

At step 408 of the method (400), a pre-defined number of learning competencies are selected from the third set of learning competencies as the plurality of skill based competencies. The plurality of skill based competencies comprises a plurality of skill based courses.

In an embodiment, the pre-defined number of learning competencies is defined based on the user requirement. The pre-defined number is a whole number that can be defined as 3, 5 or 9 as per the user requirement. However, if the user does not have any specific requirement, then the pre-defined number is set to a default value of “2”.

Further the collaborative cognitive recommendation comprises identifying a set of learning competencies from the competency catalogue base based on the competency cognitive score using a correlation technique. In an embodiment, the correlation technique includes a cosine similarity technique.

The collaborative cognitive competencies (received as a part of first input) are associated with a cognitive factor and the competency cognitive score. The collaborative cognitive recommendation technique comprises identifying a set of learning competencies from the competency catalogue base based on the competency cognitive score using the correlation technique. The competency cognitive score is a pre-defined parameter that represents cognitive abilities required by a person/user to work on the collaborative cognitive competencies and is pre-defined based on a plurality of persons/users and the corresponding cognitive scores.

The set of learning competencies are recommended to the user by identifying the learning competencies that are similar to cognitive capacities of the user in comparison with cognitive similarities with other users (based on the competency cognitive score). A cognitive correlation score is identified based on the correlation technique (cosine similarity), wherein the cognitive correlation score enables identification of another user from the competency catalogue who has similar cognitive abilities as the user. Based on the cosine similarity techniques, the similar users are identified as shown below:

$$cognitive correlation score ( {user}_{i} , {user}_{j} ) = cos θ = \frac{\vec{{user}_{i}} , \vec{{user}_{j}}}{\vec{\vert {user}_{i}} \vert \cdot \vert \vec{{user}_{j} \vert}}$$

wherein,

userᵢ is the user and

userⱼ is the another user

Further based on identification of another user with similar cognitive capacities, the competencies held by another user is recommended to the user. The collaborative cognitive competencies comprise a plurality of cognitive based courses.

The set of learning competencies recommended for the user is displayed/shared on the output module 216. The set of learning competencies includes one of or both plurality of skill based competencies and the collaborative cognitive competencies.

### Experiments

Several experiments have been conducted recommend a set of learning competencies including one of or both plurality of skill based competencies and the collaborative cognitive competencies based on the user's current competencies and the user's desired role.

In an example scenario, the competency catalogue base is generated based on the first inputs received from the plurality of sources (learning platforms). The first inputs are pre-processed, and the competency catalogue base is created with several parameters for each learning competencies or the learning courses. The learning competencies or the learning courses are associated with a cognitive factor, wherein the cognitive factor is derived from a complexity parameter. In an embodiment, the first input is received in the following formats:

Title: Relational Database Design

Learn to create an effective relational database design using proven concepts and industry knowledge. Effective database designs will help make systems faster, improve data quality, and ensure future changes are easier.

### Category: Database Design

### Complexity: Intermediate

### Title: Power BI Expert: Top Visualization Techniques in Power BI

### Become An Expert In Power BI—Master Visualization Techniques Including Sankey Diagrams, Viola Charts And More

### Category: Data Analytics

### Complexity: Simple

### Title: Advanced SQL: SQL Expert Certification Preparation Course

Complete Your Oracle SQL Knowledge from Intermediate to Advanced Level and Become a Database SQL Expert in Oracle!

### Category: Data Analytics

### Complexity: Intermediate

### Design Thinking in 3 Steps

Learn design thinking from the people who helped invent it. you'll learn a different approach to strategic problem solving so that you can create experiences customers love. You'll practice design thinking on a real-life project and equip yourself with a powerful set of tools to become more collaborative, innovative, and effective.

### Category: Design Thinking

### Complexity: Intermediate

The received first input is pre-processed in competency catalogue base in text (Unstructured) format. The natural language processing techniques has been used to for pre-processing. As a part of preprocessing, the competency data, text cleaning, tokenization & lemmatization has been performed. For every learning competency, a category model is trained learn word associations from a large corpus of text and it represents distinct word with a particular list of numbers called a vector. In this experiment it is based on title and description of the competency which will provide the root meaning of several word into a single word. In an example scenario, a processed matrix (key:value pair) will generate results also referred to as a collaborative set of learning competencies, with a key and a corresponding value/tag for the key, as shown below:

TABLE 1
Collaborative set of learning competencies

| Key | Value |
|---|---|
| Data Science | ‘Machine Learning’, ‘Tableau’, ‘SQL’, ‘Power BI’, |
| | ‘Statistics’ |
| Marketing | ‘Communication’, ‘Market Research’, ‘Problem Solving’, |
| | ‘Market Analysis’, ‘Digital Marketing’ |
| Data | ‘Power BI’, ‘Tableau’, ‘SQL’, ‘Visualization’, ‘Qlik View’ |
| Analytics | ‘Excel’ |

Further, the second input associated with a user is received, wherein the term ‘user’ and ‘user 2’ are used interchangeably in the experimentation section. The second input comprises a current competency of the user, a resume of the user, and a cognitive score of the user. An example resume of a user is shared in FIG. 5. From the resume it can be understood that that user's desired role is ‘BI Developer’ and the user's “to acquire competency” is ‘Power BI’. Further a cognitive score is generated using a cognitive assessment technique, wherein the cognitive assessment technique includes a Holland's Code Test and Gardner's Theory of Multiple Intelligences test. The cognitive score includes several parameters and corresponding scores. In the example scenario, the cognitive score with the several parameters and corresponding scores is a Realistic 0.14, Investigative 0.15, Artistic 0.24, Social 0.21, Enterprising 0.14, Conventional 0.12 scores.

Based on the resume received, the current competency of the user is: data analytics. The current competency of the user is classified as “to-acquire competency”. Upon classifying the current competency of the user as the “to-acquire competency”, a skill based recommendation technique and a collaborative cognitive recommendation technique. The skill based recommendation is performed using the category of ‘Data Analytics’ as the current competency.

The skill based recommendation technique includes identification of the first set of learning competency and the second set of learning competency. The first set of learning competency and the second set of learning competency are identified based on vectorization techniques. In the example scenario, the set of learning competency are identified using the second input and is as shown below:

### First Set of Learning Competency=[‘Tableau’, ‘SQL’, ‘Visualization’, ‘Excel’].

The second set of learning competency is identified from the competency catalogue base (a collaborative set of learning competencies) based on the frequency of occurrence of the first pre-determined factor (Title and Description in the example scenario) and the first set of learning competencies. The first set of learning competencies are compared with collaborative set of learning competencies' key value, wherein the ‘Data Analytics’ has frequency score of 4 (all 4 tags from ‘First Set of Learning Competency’), the Data Science has score 3 (3 tags from ‘First Set of Learning Competency’) and the Marketing has score 0 (0 tags from ‘First Set of Learning Competency’). Hence based on the frequency scores, the category ‘Data Analytics’ with the highest frequency score is selected to identify the second set of learning competency.

### Second Set of Learning Competency=[‘Data Analytics’: ‘Power BI’, ‘Tableau’, ‘SQL’, ‘Visualization’, ‘Qlik View’, ‘Excel’]

Further a third set of learning competencies is identified from the competency catalogue base using the second set of learning competencies based on a frequency of occurrence of a second pre-determined factor for each learning competencies from the first set of learning competencies. In the example scenario, second pre-determined factor utilized is “Title” parameter and the third set of learning competencies is identified as shown below:

### Third Set of Learning Competency=[‘Title: Power BI Expert: Top Visualization Techniques in Power BI]

Finally, a pre-defined number of learning competencies from the sorted second set of learning competencies as the plurality of skill based competencies. In an example scenario, the pre-defined number of learning competencies as user's requirement is “2”. Hence the plurality of skill based competencies selected as follows:

Plurality of skill based competencies=

### [Title: Power BI Expert: Top Visualization Techniques in Power BI

Title: Data Visualization using Power BI

The collaborative cognitive recommendation technique is performed based on cognitive score and the cognitive factor, wherein the cognitive score and the cognitive factor. A cognitive score is associated with each user and represented as a percentage between 0 and 1 generated using cognitive abilities to arrive at personality traits. In an example scenario, the user (also referred to as user 2 in experimentation section) is compared with two users (user1 and user 3), as below.

### User1: Scores are Realistic 0.19, Investigative 0.14, Artistic 0.22, Social 0.19, Enterprising 0.16, Conventional 0.10

### User2: Scores are Realistic 0.14, Investigative 0.15, Artistic 0.24, Social 0.21, Enterprising 0.14, Conventional 0.12

### User3: Scores are Realistic 0.12, Investigative 0.16, Artistic 0.25, Social 0.20, Enterprising 0.15, Conventional 0.12

The collaborative cognitive recommendation technique includes computing a cognitive correlation score computed between all the users of the system 100, as shown below:

Σ((User(N1)cognitive score)−Mean(User(N1)cognitive score)·(User(N2)cognitive score)−Mean(User(N2)cognitive score))/Square root(Σ((User(N1)cognitive score)−Mean(User(N1)cognitive score)²·(User(N2)cognitive score)−Mean(User(N2)cognitive score))²)

Based on the cognitive correlation score and the competency cognitive score associated with the set of learning competencies, it can be understood that Correlation between User 1 & User2 is 0.796, Correlation between User 1 & User3 is 0.698 and Correlation between User 2 & User3 is 0.968. Correlation coefficient closure to 1 shows strong relation and closure to 0 represents a weak relation. It is evident that, Cognitive correlation is stronger between User2 and User 3. Also, User 1 and User 2 are more similar compared to User 1 and User 3 considering cognitive scores. Upon establishing the Cognitive correlation between users, next step is to recommend learnings. Using skill based recommendation, If User 1 is recommended learnings as ‘Business Communication’, ‘Market Research for Retail’ and recommendations for User 2 are ‘UX/UI Development’, ‘Graphic Design’ and recommendations for User 3 are ‘HR Lifecycle’, ‘Labor Law’ then for high correlated users, same learnings are recommended. User 1 and User 3 have strong relation to user 2 hence ‘UX/UI Development’ and ‘Graphic Design’ which learnings for User 2 are recommended to User 1 and User 3 along with their skill based learnings. Similarly, User 2 has strong relation with User 3 so ‘HR Lifecycle’, ‘Labor Law’ (which are User 3's skill based learnings) are recommended as the along with skill-based learnings recommendations. So, considering the example scenario, if the user's cognitive score is similar to user 3, hence ‘UX/UI Development’, ‘Graphic Design’ are recommended as collaborative cognitive competencies.

Hence for the example scenario, the set of learning competencies recommended includes the plurality of skill based competencies and a plurality of collaborative cognitive competencies along with the plurality of skill based courses and the plurality of collaborative cognitive courses:
Plurality of skill based competencies: ‘Power BI’, ‘SQL’
Plurality of skill based courses: ‘Power BI Expert: Top Visualization Techniques in Power BI’, ‘Data Visualization using Power BI’, ‘SQL Basics’, ‘Advanced SQL: SQL Expert Certification Preparation Course’
Plurality of collaborative cognitive competencies: ‘UX/UI Development’, ‘Graphic Design’
Plurality of collaborative cognitive courses: ‘Design Thinking in 3 Steps’, ‘Design Thinking Basics’, ‘Elements of Graphic Design’. ‘Graphic Designing using Maya’

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The disclosure relates to the field of recommendation of learning competencies. The usage of competency-based learning platforms is growing as it provides a safe learning environment where learners/users can learn from the comfort of their homes at a convenient time. However, one of the challenges with competency-based learning platforms is to identify learning competencies/courses relevant to a learner as exhaustive material is available on the internet. The disclosure addresses the challenges by providing techniques for personalized recommendation of cognitive based learning competencies and skill based learning competencies. The disclosed techniques recommend cognitive based learning competencies and skill based learning competencies based on several techniques that include a machine learning, a Natural Language Processing (NLP), a skill based recommendation technique and a collaborative cognitive recommendation technique. Hence the disclosure is an approach to enable a learner to assess the learner's current competencies and identify learning competencies that would empower them to move towards an improved competency.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor-implemented method for recommendation of cognitive and skill based learning competencies comprising:
receiving a first input from a plurality of sources, via one or more hardware processors, wherein the first input comprises information on a plurality of learning competencies associated with the plurality of sources, wherein the plurality of sources comprises a plurality of competency learning platforms;
generating a competency catalogue base by applying a machine learning technique on the first input, via the one or more hardware processors, wherein the competency catalogue base comprises of the plurality of learning competencies;
receiving a second input associated with a user, via the one or more hardware processors, wherein the second input comprises a current competency of the user, a resume of the user, and a cognitive score of the user;
classifying the current competency of the user to one of an acquired competency, an additionally acquired competency, and a to-acquire competency, via the one or more hardware processors, using the plurality of second input and the competency catalogue base; and
recommending a set of learning competencies for the user based on the classification, via the one or more hardware processors, by performing one of:
upon classifying the current competency of the user as the to-acquire competency, performing a skill based recommendation technique and a collaborative cognitive recommendation technique using the competency catalogue base and the second input;
upon classifying the current competency of the user as the acquired competency, performing the collaborative cognitive recommendation technique using the competency catalogue base and the second input; and
upon classifying the current competency of the user as the additionally acquired competency, performing the collaborative cognitive recommendation technique using the competency catalogue base and the second input.

2. The method of claim 1, wherein each learning competency among the plurality of learning competencies comprises of one of a plurality of skill based competencies and a plurality of collaborative cognitive competencies, wherein the plurality of learning competencies is associated with a cognitive factor and the collaborative cognitive competencies is associated with a competency cognitive score.

3. The method of claim 1, wherein the cognitive score is determined based on a cognitive assessment technique, where the cognitive assessment technique comprises determining the cognitive score based on a cognitive assessment test, wherein the cognitive assessment test comprises a Holland codes test and a Gardeners theory of multiple intelligences test.

4. The method of claim 1, wherein the skill based recommendation technique identifies a set of skill based competencies to be recommended for the user and the collaborative cognitive recommendation technique identifies a set of collaborative cognitive competencies to be recommended for the user.

5. The method of claim 1, wherein performing the skill based recommendation technique comprises:
identifying a first set of learning competencies using the second input based on a vectorization technique;
identifying a second set of learning competencies from the competency catalogue base using the first set of learning competencies, based on a frequency of occurrence of a first pre-defined factor for each learning competencies in the first set of learning competencies;
identifying a third set of learning competencies from the competency catalogue base using the second set of learning competencies based on a frequency of occurrence of a second pre-defined factor for each learning competencies in the first set of learning competencies; and
selecting a pre-defined number of learning competencies from the third set of learning competencies as the plurality of skill based competencies.

6. The method of claim 1, wherein the collaborative cognitive recommendation technique comprises identifying a set of learning competencies from the competency catalogue base based on the competency cognitive score using a correlation technique.

7. A system, comprising:
an input/output interface;
one or more memories; and
one or more hardware processors, the one or more memories coupled to the one or more hardware processors, wherein the one or more hardware processors are configured to execute programmed instructions stored in the one or more memories, to:
receive a first input from a plurality of sources, via one or more hardware processors, wherein the first input comprises information on a plurality of learning competencies associated with the plurality of sources, wherein the plurality of sources comprises a plurality of competency learning platforms;
generate a competency catalogue base by applying a machine learning technique on the first input, via the one or more hardware processors, wherein the competency catalogue base comprises of the plurality of learning competencies;
receive a second input associated with a user, via the one or more hardware processors, wherein the second input comprises a current competency of the user, a resume of the user, and a cognitive score of the user;
classify the current competency of the user to one of an acquired competency, an additionally acquired competency, and a to-acquire competency, via the one or more hardware processors, using the plurality of second input and the competency catalogue base; and
recommend a set of learning competencies for the user based on the classification, via the one or more hardware processors, by performing one of:
upon classifying the current competency of the user as the to-acquire competency, perform a skill based recommendation technique and a collaborative cognitive recommendation technique using the competency catalogue base and the second input;
upon classifying the current competency of the user as the acquired competency, perform the collaborative cognitive recommendation technique using the competency catalogue base and the second input; and
upon classifying the current competency of the user as the additionally acquired competency, perform the collaborative cognitive recommendation technique using the competency catalogue base and the second input.

8. The system of claim 7, wherein the one or more hardware processors are configured by the instructions to determine cognitive based on a cognitive assessment technique, where the cognitive assessment technique comprises determining the cognitive score based on a cognitive assessment test, where the cognitive assessment test comprises a Holland codes test and a Gardener's theory of multiple intelligences test.

9. The system of claim 7, wherein the one or more hardware processors are configured by the instructions to perform the skill based recommendation technique comprises:
identifying a first set of learning competencies using the second input based on a vectorization technique;
identifying a second set of learning competencies from the competency catalogue base using the first set of learning competencies, based on a frequency of occurrence of a first pre-defined factor for each learning competencies in the first set of learning competencies;
identifying a third set of learning competencies from the competency catalogue base using the second set of learning competencies based on a frequency of occurrence of a second pre-defined factor for each learning competencies in the first set of learning competencies; and
selecting a pre-defined number of learning competencies from the third set of learning competencies as the plurality of skill based competencies.

10. The system of claim 7, wherein the one or more hardware processors are configured by the instructions to perform the collaborative cognitive recommendation technique comprising of identifying a set of learning competencies from the competency catalogue base based on the competency cognitive score using a correlation technique.

11. One or more non-transitory machine-readable information storage mediums comprising one or more instructions which when executed by one or more hardware processors causes a recommendation of cognitive and skill based learning competencies thereof by:
receiving a first input from a plurality of sources, via one or more hardware processors, wherein the first input comprises information on a plurality of learning competencies associated with the plurality of sources, wherein the plurality of sources comprises a plurality of competency learning platforms;
generating a competency catalogue base by applying a machine learning technique on the first input, via the one or more hardware processors, wherein the competency catalogue base comprises of the plurality of learning competencies;
receiving a second input associated with a user, via the one or more hardware processors, wherein the second input comprises a current competency of the user, a resume of the user, and a cognitive score of the user;
classifying the current competency of the user to one of an acquired competency, an additionally acquired competency, and a to-acquire competency, via the one or more hardware processors, using the plurality of second input and the competency catalogue base; and
recommending a set of learning competencies for the user based on the classification, via the one or more hardware processors, by performing one of:
upon classifying the current competency of the user as the to-acquire competency, performing a skill based recommendation technique and a collaborative cognitive recommendation technique using the competency catalogue base and the second input;
upon classifying the current competency of the user as the acquired competency, performing the collaborative cognitive recommendation technique using the competency catalogue base and the second input; and
upon classifying the current competency of the user as the additionally acquired competency, performing the collaborative cognitive recommendation technique using the competency catalogue base and the second input.
